(19) United States
(12) Patent Application Publication
(10) Pub. No.: US 2005/0036302 A1
(43) Pub. Date: Feb. 17, 2005

(54) Illuminating device for hand-held bar code reader

(76) Inventor: Chris Yeh, Hsin-Tien City (TW)

Correspondence Address: Yi-Wen Tseng, 509 Roosevelt BLVD. #D306, Fall Church, VA, 22044, US

(21) Appl. No.: 10/641,141

(22) Filed: Aug. 15, 2003

(51) Int. Cl. F21V 33/00

(52) U.S. Cl. 362/109

(57) ABSTRACT

An illuminating device for hand-held bar code reader that installs a light emitting device next to a reading window of a bar code reader. The light projection direction of the light emitting device is parallel to a scanning light emitted from the interior of the reading window. The light emitting device is controlled by a switch. The switch is a two-stage press-type switch. When the switch is pressed into a first stage, the light emitting device is activated to illuminate. When the switch is pressed into a second stage, the scanning light is emitted for bar code reading. Thereby, the bar code can be read in an environment with insufficient light.

### BACKGROUND OF THE INVENTION

The present invention relates generally to an illuminating device for a hand-held bar code reader and, more particularly, to a bar code reader which includes an illuminating device next to a reading window thereof.

A bar code includes a series of digits represented by parallel bars. Being read by an optical reader and decoded by a computer, these bars are converted into digits. The computer discriminates the serial number, identification number or other symbols for the articles represented by such digits. The bar code that provides a series of digits to the computer includes a plurality of automatic management symbols for manufacturing, wholesale and marketing the article represented thereby. As the bar code can be used to discriminate certain device in a computer management process, it is widely applicable in various business, including product flow, shipment, and documentation in banking industry and government.

As mentioned above, a bar code reader is required to read the bar code, and various kinds of bar code readers have been developed in the market. The hand-held bar code reader is particularly convenient and practical due to its portability. However, in the condition when illumination is poor, such as in a warehouse which does not have sufficient lighting equipment at night, external lighting equipment is required to correctly locate the position of the bar code for reading.

### BRIEF SUMMARY OF THE INVENTION

The present invention provides an illuminating device for a hand-held bar code reader. A light emitting device is installed next to a reading window of the bar code reader. The light emitting device is controlled by a two-stage switch. In the first stage of the switch, the light emitting device is activated to emit a light for locating the position of the bar code. In the second stage of the switch, a scanning light is generated to perform bar code reading process. As the hand-held bar code reader has the built-in illumination function, an external illuminating device is not required when the environment has insufficient light.

### BRIEF DESCRIPTION OF THE DRAWINGS

These, as well as other features of the present invention, will become more apparent upon reference to the drawings wherein:

FIG. 1 shows a perspective view of a hand-held bar code reader provided by the present invention;

FIG. 2 shows a block diagram of the hand-held bar code reader; and

FIG. 3 shows a circuit diagram of the hand-held bar code reader.

### DETAILED DESCRIPTION OF THE INVENTION

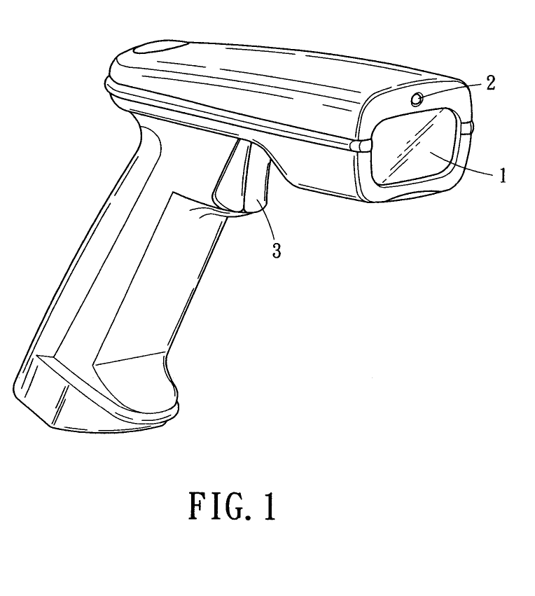

Referring to FIG. 1, a perspective view of a hand-held bar code reader provided by the present invention is illustrated. In FIG. 1, a gun-type hand-held bar code reader is exemplarily illustrated. It is appreciated that the hand-held bar code reader may also be manufactured in other configurations without exceeding spirit and scope of the present invention. As a matter of fact, the present invention can be applied to various types of hand-held bar code readers, such as high-level intelligent data collector (that is, a combination of a palm pilot and a bar code reader), which is irrelevant to the scan engine, including mask type or laser type, adapted by the bar code reader. As shown, a light emitting device 2 is installed at a shell next to a reading window 1 of the bar code reader. The light emitting device 2 includes a light emitting diode or a light bulb, which projects a light beam approximately parallel to a scanning light emitted from the reading window 1, such that the illuminated area of the light emitting device is substantially overlapped with the scanning area of the scanning light. Therefore, the bar code scanning process can be performed directly without the additional step for adjusting the scanning position, or with a minor adjustment. The light emitting device 2 is controlled by a two-stage switch 3. The switch 3 includes a push-button switch or other type of switch for reading specific type of bar code. For the gun-type bar code reader as shown in FIG. 1, the push-button switch is preferred. As mentioned above, the switch 3 has two operation stages. By pressing switch 3 once, the bar code reader 1 is switched to a first stage, under which the light emitting device 2 is activated to illuminate. With the illumination, the bar code is adjusted to an appropriate position aligned with the scanning window. When the bar code is aligned with the scanning window, the switch 3 is pressed again to switch the bar code reader 1 into a second stage, in which the scanning light is switched one and projects through the scanning window. Preferably, the light emitting device 2 continuously emits a light when the scanning light is switched on. That is, during the second stage, the scanning light and the light generated by the light emitting device are simultaneously switched on.

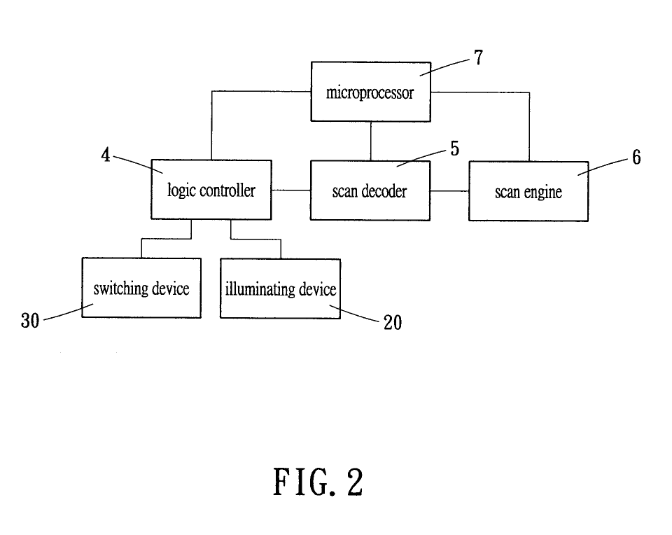

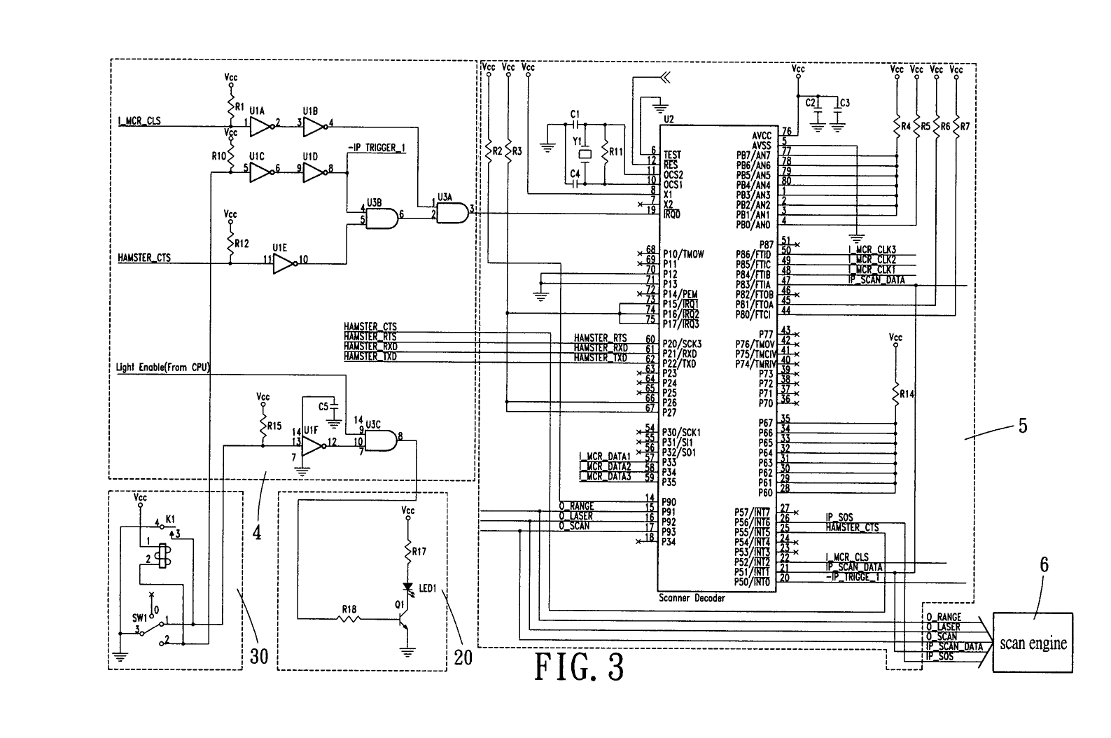

FIG. 2 shows a block diagram of the bar code reader. The bar code reader 1 includes a logic controller 4, a scan decoder 5 and a scan engine 6 controlled by a microprocessor 7 to perform scan and decode operations. The operations of these devices are not essential to the present invention and are not discussed in detailed. The present invention is characterized in the related portions of the switch device 30, the illuminating device 20 and the logic controller 4. That is, the switch 3 is controlled by the logic controller 4 to control the operations of the scan decoder 5 and the illuminating device 20. FIG. 3 shows a circuit diagram of the bar code reader 1. As shown in FIG. 3, the switch 30 includes a switch SW1 and a relay K1. The illuminating device 20 includes a light emitting diode LED1 and a transistor Q1 used as a relay. The switch SW1 has two operation stages, and three nodes 0, 1, 2. The switch SW1 can be operated in stages or continuously. In each operation stage, the respective node 0, 1 or 2 is conducted with a common terminal. The node 0 is a floating terminal, such that when the switch SW1 is pressed to node 0, the light emitting diode 2 and the scan engine 6 are both off. The switch SW1 has a common terminal (node 3) serving as a ground. When the switch SW1 is pressed into the first stage, that is, switched to node 1, a low potential connected to ground is supplied. The logic control 4 then outputs a trigger signal to the transistor Q1 according to the potential variation, so as to conduct the light emitting diode LED1 for illumination. When the switch SW1 is switched to the second stage, node 2 is conducted with the low potential of the ground, and the logic controller 4 outputs another trigger signal to the scan decoder 5 according to the potential variation, so as to activate the scan engine and lit up the scanning light to perform scanning process. Meanwhile, though the node 1 is floating, as the negative electrode of the trigger coil of the relay K1 is connected to the node 2, and the positive electrode is connected to a positive power source Vcc, the trigger coil magnetized to conduct the node 1 and ground (that is, two terminals are connected two switching nodes of the relay K1). Therefore, a low potential for connecting ground is maintained, and the light emitting diode LED1 is continuously on. By further pressing the switch SW1, the off status is retrieved, and the node 0 is connected.

According to the present invention, the present invention does not provide additional illuminating device for a hand-held bar code reader, but also provides a simple and convenient switch control thereof. Therefore, the bar coder can be correctly read by the hand-held bar code reader in the environment with insufficiently illumination.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. An illuminating device for a hand-held bar code reader, comprising a light emitting device controlled by a two-stage switch, wherein when the switch is switched to a first operation stage, the light emitting device is switched on for illuminating a bar code, and when the switch is switched to a second operation stage, a scan light is generated for reading a bar code.

2. The device of claim 1, wherein the hand-held bar code reader includes a reading window, and the light emitting diode is installed next to the reading window.

3. The device of claim 1, wherein the light emitting device is operative to emit a light substantially parallel to a scan light generated from an interior of the reading window.

4. The device of claim 1, wherein the switch includes a press-button switch.
